(19) United States
(12) Patent Application Publication
(10) Pub. No.: US 2026/0089318 A1
(43) Pub. Date: Mar. 26, 2026

(54) IMAGE CODING METHOD, ELECTRONIC DEVICE, AND STORAGE MEDIUM

(71) Applicant: Beijing Baidu Netcom Science Technology Co., Ltd., Beijing (CN)

(72) Inventor: Jiaojiao ZHANG, Beijing (CN)

(21) Appl. No.: 19/408,831

(22) Filed: Dec. 4, 2025

(30) Foreign Application Priority Data
May 22, 2025 (CN) 202510669351.X

(51) Int. Cl. H04N 19/11; H04N 19/149; H04N 19/176

(52) U.S. Cl. CPC H04N 19/11; H04N 19/149; H04N 19/176

(57) ABSTRACT

An image coding method, which relates to the field of image processing technologies, and in particular to the fields of video compression and image encoding/decoding technologies, includes: partitioning an image to be processed into a plurality of coding units; determining, for any coding unit, a gradient histogram of the coding unit and respective gradient histograms of a plurality of sub-blocks of the coding unit, according to gradients of pixels in the coding unit; determining consistency between a dominant gradient direction of each of the plurality of sub-blocks and a dominant gradient direction of the coding unit according to the gradient histograms; determining a set of candidate coding modes from a plurality of angular coding modes according to the consistency; and determining a target angular coding mode to encode the coding unit, according to rate-distortion costs of the angular coding modes in the set of candidate coding modes.

This application claims the benefit of priority to Chinese Patent Application No. 202510669351.X, filed on May 22, 2025. The entire contents of this application are hereby incorporated herein by reference.

### TECHNICAL FIELD

The present disclosure relates to the field of image processing technologies, and in particular, to the fields of video compression and image encoding/decoding technologies. More specifically, the present disclosure provides an image coding method, an electronic device, and a storage medium.

### BACKGROUND

Intra prediction technology is an important part of image processing performed using video encoders. By predicting pixel values within an image, a compression efficiency of the image is improved. Since there are many predicted coding modes, complex calculations are often required to determine the optimal coding mode, which results in low coding efficiency.

### SUMMARY

The present disclosure provides an image coding method, an electronic device, and a storage medium.

According to an aspect, an image coding method is provided, including: partitioning an image to be processed into a plurality of coding units; determining, for any coding unit, a gradient histogram of the coding unit and respective gradient histograms of a plurality of sub-blocks of the coding unit, according to gradients of pixels in the coding unit; determining consistency between a dominant gradient direction of each of the plurality of sub-blocks and a dominant gradient direction of the coding unit according to the gradient histograms; determining a set of candidate coding modes from a plurality of angular coding modes according to the consistency; and determining a target angular coding mode to encode the coding unit, according to rate-distortion costs of the angular coding modes in the set of candidate coding modes.

According to another aspect, an electronic device is provided, including: at least one processor; and a memory communicatively connected to the at least one processor, where the memory stores instructions executable by the at least one processor, and the instructions, when executed by the at least one processor, are configured to cause the at least one processor to perform the method provided in the present disclosure.

According to another aspect, a non-transitory computer-readable storage medium having computer instructions therein is provided, where the computer instructions are configured to cause a computer to perform the method provided in the present disclosure.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

The accompanying drawings are provided to facilitate a better understanding of the solution and do not constitute limitations to the present disclosure. In the accompanying drawings:

FIG. 1 shows a flowchart of an image coding method according to an embodiment of the present disclosure;

FIG. 2 shows a schematic diagram of angular coding modes according to an embodiment of the present disclosure;

FIG. 3 shows a flowchart of an image coding method according to another embodiment of the present disclosure;

FIG. 4 shows a block diagram of an image coding apparatus according to an embodiment of the present disclosure; and

FIG. 5 shows a block diagram of an electronic device for implementing the image coding method according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the collection, storage, use, processing, transmission, provision and disclosure of user personal information involved all comply with relevant laws and regulations, and do not violate public order and good customs.

In the technical solutions of the present disclosure, user authorization or consent is obtained prior to the acquisition or collection of any user personal information.

First, explanations are provided for technical terms involved in embodiments of the present disclosure.

Mode prediction refers to predicting a coding mode for a current coding unit to improve a compression efficiency. In the mode prediction for coding modes, an encoder may predict the most likely coding mode for the current block by considering the surrounding environment of the current coding unit, such as the coding mode for an adjacent block, a motion information of the current block, a texture information of the current block, and the like. According to a prediction result, the encoder may then select the most suitable coding mode for compression.

Intra prediction refers to predicting a current pixel according to adjacent already-encoded pixels within the same frame, using a spatial correlation within a video frame, so as to effectively remove spatial redundancy in the video.

Distortion refers to a degradation of image quality caused by data compression. In order to reduce data volume, video coding typically applies a certain degree of compression to an image to be processed, and such compression may cause a loss of certain details of the image, thereby resulting in distortion in the video.

RDO (Rate Distortion Optimized) refers to a strategy in which both bitrate and distortion are considered when calculating a cost function, such that a low distortion is maintained while ensuring the bitrate.

RDOCost (Rate Distortion Optimized Cost, also referred to as rate-distortion cost hereinafter) refers to a cost required to balance bitrate and distortion under the RDO strategy.

QP (quantization parameter) is used to control bitrate and coding distortion. A larger QP results in greater distortion and lower bitrate.

SATD (Sum of Absolute Transformed Difference) is a metric representing a magnitude of video residual signals, which is the sum of absolute values of coefficients produced by applying a Hadamard transform to the residual.

STADCost (Sum of Absolute Transformed Difference_Cost, also referred to as residual cost hereinafter) is a cost calculated using SATD as the metric. STADCost may quickly evaluate the cost of a prediction mode with low computational complexity.

In some examples, a process of intra prediction may include: acquiring an image to be processed, partitioning the image to be processed into a plurality of coding units (CUs), and predicting pixel values within each coding unit based on spatial correlation in the image. A texture and structural information of the image may affect prediction accuracy of different coding modes. By applying a mode prediction, a coding mode most suitable for the coding unit may be determined for compression. Therefore, determining the coding mode suitable for the coding unit through mode prediction may improve coding quality.

The encoder may determine the optimal coding mode by calculating residual costs and rate-distortion costs for different modes. The residual cost has lower computational complexity, and the rate-distortion cost has higher computational complexity. The encoder may calculate residual costs of various coding modes for the coding unit, and then pre-screen based on the residual costs, and then calculate rate-distortion costs of multiple screened coding modes to determine a coding mode suitable for the coding unit, thereby reducing the computational complexity of intra prediction.

Intra prediction of an image involves a large number of coding modes. For example, the H.266 encoder has increased the number of angle-based directional intra prediction modes from 33 in the H.265 encoder to 65. Together with the existing DC (Direct Current average) mode and Planar (planar weighted average) mode, there are a total of 67 coding modes. In addition to the above 67 coding modes, the H.266 encoder extends intra prediction with several additional coding modes, including multi-reference line coding mode, wide-angle coding mode, matrix-based weighted averaging coding mode, and others. During intra prediction, the costs of all coding modes are separately calculated to determine the optimal coding mode, which leads to excessively high computational complexity of intra prediction and affects coding efficiency. In view of the above, the present disclosure provides an image coding method in which a feature analysis is performed on information such as texture and structure of the image to be processed to remove unnecessary coding modes, thereby reducing the number of calculations required during intra prediction and improving coding efficiency.

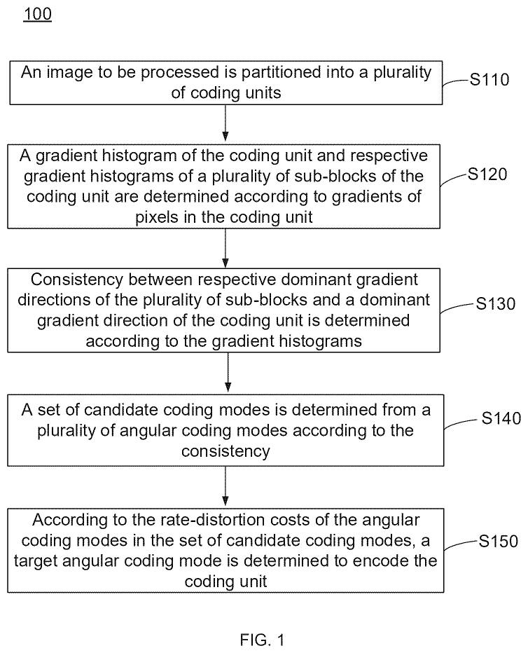

The image coding method of the present disclosure is described below with reference to FIG. 1 to FIG. 3.

FIG. 1 shows a flowchart of an image coding method according to an embodiment of the present disclosure.

As shown in FIG. 1, an image coding method 100 of this embodiment includes operation S110 to operation S150.

In operation S110, an image to be processed is partitioned into a plurality of coding units.

The image to be processed may be an image frame of a video file input to an encoder for processing. According to coding requirements, the image to be processed may be partitioned into a plurality of CUs (coding units), and intra prediction may be performed for each CU of the image to be processed.

In operation S120, a gradient histogram of the coding unit and respective gradient histograms of a plurality of sub-blocks of the coding unit are determined according to gradients of pixels in the coding unit.

In embodiments of the present disclosure, the gradient of the pixel refers to a degree of change in pixel value between a preceding pixel of the current pixel and a succeeding pixel of the current pixel. A sub-block is a coding region obtained by partitioning the coding unit. A gradient magnitude of each pixel may be obtained by the following equations:

$${G}_{x} ( x , y ) = I ( x + 1 , y ) - I ( x - 1 , y ) \qquad ( 1 )$$

$${G}_{y} ( x , y ) = I ( x , y + 1 ) - I ( x , y - 1 ) \qquad ( 2 )$$

$$G ( x , y ) = \sqrt{{{G}_{x} ( x , y )}^{2} + {{G}_{y} ( x , y )}^{2}} \qquad ( 3 )$$

$$θ ( x , y ) = arc tan ( \frac{{G}_{y} ( x , y )}{{G}_{x} ( x , y )} ) \qquad ( 4 )$$

where Gₓ(x,y) represents a gradient magnitude of a pixel at coordinates (x,y) in the x-axis direction; G_{y}(x,y) represents a gradient magnitude of the pixel at coordinates (x,y) in the y-axis direction; G (x,y) represents a gradient magnitude of the pixel at coordinates (x,y); I(x,y) represents a pixel value of the pixel at coordinates (x,y); and θ(x,y) represents a gradient direction of the pixel at coordinates (x,y).

A range of gradient directions of pixels may be divided into a plurality of angular intervals. By accumulating the gradient magnitudes of pixels whose gradient directions fall within the same angular interval, a total gradient magnitude corresponding to each angular interval may be obtained. The gradient histogram of the coding unit may refer to a distribution map of gradient magnitudes across different angular intervals obtained based on all pixel values in the coding unit, and the gradient histogram of the coding unit may represent a distribution of gradients of pixels within the coding unit. The gradient histogram of the sub-block may refer to a distribution map of gradient magnitudes across different angular intervals obtained based on all pixel values within the sub-block of the coding unit, and the gradient histogram of the sub-block may represent a distribution of gradients of pixels within the sub-block.

For example, the range of the gradient directions of pixels may be divided into 32 angular intervals. By calculating the gradient of each pixel within the coding unit, the gradient magnitude and gradient direction of each pixel may be obtained. The angular interval to which a pixel belongs may be determined according to the gradient direction of the pixel. It may then be determined that, for example, the total gradient magnitude in angular interval 1 is 10, the total gradient magnitude in angular interval 2 is 15, . . . , and the total gradient magnitude in angular interval 32 is 5. According to the angular intervals and the corresponding total gradient magnitudes, the gradient histogram of the coding unit may be obtained, which represents the distribution of the gradient directions of pixels within the coding unit across the angular intervals.

In operation S130, consistency between respective dominant gradient directions of the plurality of sub-blocks and a dominant gradient direction of the coding unit is determined according to the gradient histograms.

In embodiments of the present disclosure, the dominant gradient direction may refer to an angular interval having a maximum total gradient magnitude in the gradient histogram. The consistency may refer to the number or proportion of sub-blocks having the same dominant gradient direction as the coding unit.

For example, the gradient histograms of the coding unit and four sub-blocks may be obtained through calculation. According to the gradient histograms, the dominant gradient direction B of the coding unit and the dominant gradient directions B01 to B04 of the four sub-blocks may be determined. By counting the number of sub-blocks whose dominant gradient direction is consistent with the dominant gradient direction B, the consistency between the respective dominant gradient directions of the sub-blocks and the dominant gradient direction of the coding unit may be determined. The greater the number of sub-blocks whose dominant gradient direction is consistent with the dominant gradient direction B, the higher the consistency between the respective dominant gradient directions of the sub-blocks and the dominant gradient direction of the coding unit.

In operation S140, a set of candidate coding modes is determined from a plurality of angular coding modes according to the consistency.

In embodiments of the present disclosure, the angular coding mode refers to a coding mode based on a specific angular direction. In an angular interval, there may be a plurality of angular coding modes whose angular directions fall within the angular interval. The consistency between the respective dominant gradient directions of the sub-blocks and the dominant gradient direction of the coding unit represents the consistency between texture directions of the sub-blocks and a texture direction of the coding unit. A high level of consistency indicates that the coding unit exhibits prominent texture features and texture directions, and that the feature distribution of pixels in each sub-block is close to the feature distribution of the coding unit. A low level of consistency indicates that the texture features of the coding unit are not obvious and that the feature distribution of pixels in each sub-block is different from the feature distribution of the coding unit. The set of candidate coding modes refers to a set of angular coding modes closely aligned with the feature distribution of the coding unit.

For example, angular interval 1 may represent angular directions between 0 degrees and 5 degrees. The angular coding modes may include coding modes based on angular directions of 1 degree, 3 degrees, and 5 degrees. Thus, angular interval 1 corresponds to three different angular coding modes based on angular directions of 1 degree, 3 degrees, and 5 degrees.

In an example, if the dominant gradient direction of the coding unit corresponds to angular interval 1, and the consistency between the respective dominant gradient directions of the sub-blocks and the dominant gradient direction of the coding unit is high, the three angular coding modes corresponding to angular interval 1 may be determined as the set of candidate coding modes.

In another example, if the dominant gradient direction of the coding unit corresponds to angular interval 1, but the consistency between the respective dominant gradient directions of the sub-blocks and the dominant gradient direction of the coding unit is low, it indicates that the feature distribution within the coding unit is complex. If only the three angular coding modes corresponding to angular interval 1 are determined as the set of candidate coding modes, the coding accuracy of the coding unit may be reduced. Other angular coding modes need to be added to the set of candidate coding modes for calculation, so as to obtain a coding mode with higher accuracy.

In operation S150, according to the rate-distortion costs of the angular coding modes in the set of candidate coding modes, a target angular coding mode is determined to encode the coding unit.

In embodiments of the present disclosure, the rate-distortion cost (Rate Distortion Optimized Cost, RDOCost) refers to a cost required to achieve a balance between bitrate and distortion. The rate-distortion cost may accurately reflect the coding quality of the coding unit when using different angular coding modes. According to the rate-distortion cost, a coding mode having the best tradeoff between coding quality and bitrate may be selected from the set of candidate coding modes as the target coding mode.

According to embodiments of the present disclosure, by statistically analyzing the gradient magnitudes and the gradient directions of pixels within the coding unit, and by determining the consistency between the dominant gradient direction of the coding unit and the respective dominant gradient directions of the sub-blocks in the coding unit, a set of candidate coding modes that matches the texture direction of the coding unit may be selected. By calculating the rate-distortion costs of the angular coding modes in the set of candidate coding modes, the angular coding mode having the minimum rate-distortion cost may be selected as the target angular coding mode to encode the coding unit. This reduces the number of calculations required for intra prediction coding modes and improves image coding efficiency.

In embodiments of the present disclosure, determining the target angular coding mode according to the rate-distortion costs of the angular coding modes in the set of candidate coding modes includes determining, from the set of candidate coding modes, an angular coding mode having a minimum rate-distortion cost as the target angular coding mode to encode the coding unit.

In embodiments of the present disclosure, the lower the rate-distortion cost corresponding to an angular coding mode, the better tradeoff between coding quality and bitrate achieved by the angular coding mode. By calculating the rate-distortion costs of the angular coding modes in the set of candidate coding modes, the target angular coding mode having the minimum rate-distortion cost may be determined as the optimal coding mode for the coding unit.

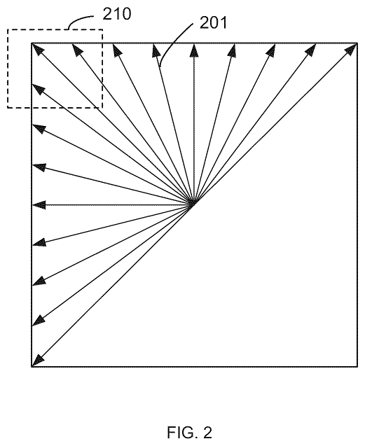

FIG. 2 shows a schematic diagram of angular coding modes according to an embodiment of the present disclosure.

As shown in FIG. 2, an arrow 201 pointing from a center of the coding unit to an edge of the coding unit represents an angular direction corresponding to an angular coding mode. An angular interval 210 may include angular coding modes having angular directions that form angles between 30 degrees to 60 degrees with respect to the horizontal direction.

In embodiments of the present disclosure, the plurality of angular coding modes include M angular coding modes. Determining the gradient histogram of the coding unit and the respective gradient histograms of the plurality of sub-blocks of the coding unit according to the gradients of pixels within the coding unit includes: determining N gradient histograms of the coding unit respectively corresponding to N angular intervals, according to a distribution of gradient directions of pixels within the coding unit across the N angular intervals, where the N angular intervals are obtained by dividing M angular directions respectively corresponding to the M angular coding modes, and N is an integer less than M; and for each sub-block, determining N gradient histograms of the sub-block respectively corresponding to the N angular intervals, according to a distribution of gradient directions of pixels within the sub-block across the N angular intervals.

According to embodiments of the present disclosure, the M angular coding modes respectively correspond to M angular directions. The N angular intervals are obtained by dividing the M angular directions, and each angular interval may include one or more angular coding modes corresponding to the angular directions within that angular interval. By statistically analyzing the gradient directions of pixels, a total gradient magnitude of pixels whose gradient directions fall within each angular interval may be obtained. According to pixel values of the coding unit, total gradient magnitudes respectively corresponding to the N angular intervals may be obtained, thereby determining the gradient histograms corresponding to the N angular intervals. According to pixel values of each sub-block, total gradient magnitudes respectively corresponding to the N angular intervals may be obtained, thereby determining the gradient histograms of each sub-block corresponding to the N angular intervals.

For example, as shown in FIG. 2, the angular interval 210 corresponds to angular directions forming angles between 30 degrees and 60 degrees with respect to the horizontal direction, and includes angular coding modes corresponding to three angular directions.

In embodiments of the present disclosure, there may be 65 angular coding modes and 32 angular intervals, and each angular interval includes three angular coding modes. The angular direction of a third angular coding mode included in a previous angular interval of the current angular interval overlaps with the angular direction of a first angular coding mode included in the current angular interval.

For example, angular interval 1 may include angular coding modes corresponding to 1 degree, 3 degrees, and 5 degrees, and angular interval 2 may include angular coding modes corresponding to 5 degrees, 7 degrees, and 9 degrees.

In embodiments of the present disclosure, determining N gradient histograms of the coding unit respectively corresponding to N angular intervals according to the distribution of the gradient directions of pixels within the coding unit across the N angular intervals includes: for each angular interval, determining a gradient histogram corresponding to the angular interval according to the gradient magnitudes of pixels whose gradient directions fall within the angular interval; and determining N gradient histograms respectively corresponding to the N angular intervals as the N gradient histograms of the coding unit respectively corresponding to the N angular intervals.

According to embodiments of the present disclosure, by accumulating the gradient magnitudes of pixels whose gradient directions fall within the range of an angular interval, a total gradient magnitude corresponding to the angular interval may be obtained, and the gradient histogram corresponding to the angular interval may be determined. Based on the gradient magnitudes and gradient directions of all pixels within the coding unit, the total gradient magnitudes respectively corresponding to the N angular intervals may be obtained, thereby determining the gradient histograms corresponding to the N angular intervals.

For example, as shown in FIG. 2, the angular interval 210 corresponds to angular directions forming angles between 30 degrees and 60 degrees with respect to the horizontal direction. When calculating the gradient directions of pixels within the coding unit, by accumulating gradient magnitudes of pixels whose gradient directions fall within the range of 30 degrees to 60 degrees, a total gradient magnitude corresponding to the angular interval 210 may be obtained. By following the same process, the total gradient magnitudes corresponding to the N angular intervals may be obtained to construct the gradient histograms.

In embodiments of the present disclosure, the dominant gradient direction may be determined as follows: the angular interval corresponding to the gradient histogram having the maximum total gradient magnitude among the N gradient histograms of the coding unit is determined as the dominant gradient direction of the coding unit; and for each sub-block, the angular interval corresponding to the gradient histogram having the maximum total gradient magnitude among the N gradient histograms of the sub-block is determined as the dominant gradient direction of the sub-block.

According to embodiments of the present disclosure, after the total gradient magnitudes respectively corresponding to the N angular intervals are determined, the dominant gradient direction of the coding unit and the dominant gradient directions of the sub-blocks may be determined based on the values of the total gradient magnitudes.

For example, the gradient histograms of the coding unit corresponding to the N angular intervals may be obtained according to the gradient directions and gradient magnitudes of pixels within the coding unit. According to the gradient histograms, it is possible to determine that the angular interval corresponding to the maximum total gradient magnitude is angular interval 1, and the angular direction range of 0 to 5 degrees corresponding to that angular interval may be determined as the dominant gradient direction of the coding unit.

For example, the gradient histograms of the sub-block corresponding to the N angular intervals may be obtained according to the gradient directions and gradient magnitudes of pixels within the sub-block. According to the gradient histograms, it is possible to determine that the angular interval corresponding to the maximum total gradient magnitude is angular interval 2, and the angular direction range of 5 to 10 degrees corresponding to that angular interval may be determined as the dominant gradient direction of the sub-block.

In embodiments of the present disclosure, in response to the consistency meeting a preset condition, a set of candidate coding modes is determined from the M angular coding modes according to the angular interval corresponding to the dominant gradient direction of the coding unit; and in response to the consistency not meeting the preset condition, a set of candidate coding modes is determined from the M angular coding modes according to a confidence level of the dominant gradient direction of the coding unit.

According to embodiments of the present disclosure, the consistency meeting the preset condition indicates that the feature distribution of pixels within the sub-blocks is close to the feature distribution of the coding unit. The consistency meeting the preset condition may refer to that the number of sub-blocks whose dominant gradient directions are consistent with the dominant gradient direction of the coding unit is greater than or equal to a quantity threshold, or refer to that a proportion of sub-blocks whose dominant gradient directions are consistent with the dominant gradient direction of the coding unit is greater than or equal to a proportion threshold. For example, when the coding unit includes four sub-blocks, the quantity threshold may be two, or the proportion threshold may be 50%. In this case, the angular coding modes matching the dominant gradient direction of the coding unit may be added to the set of candidate coding modes.

For example, if the dominant gradient direction of the coding unit corresponds to angular interval 1, and angular interval 1 includes three angular coding modes, the three angular coding modes falling within angular interval 1 may be added to the set of candidate coding modes.

According to embodiments of the present disclosure, the consistency not meeting the preset condition indicates that the feature distribution of pixels within the sub-blocks is different from the feature distribution of the coding unit. The consistency not meeting the preset condition may refer to that the number of sub-blocks whose dominant gradient directions are consistent with the dominant gradient direction of the coding unit is less than or equal to the quantity threshold, or refer to that the proportion of sub-blocks whose dominant gradient directions are consistent with the dominant gradient direction of the coding unit is less than or equal to the proportion threshold. In this case, the confidence level of the dominant gradient direction needs to be considered.

In embodiments of the present disclosure, determining the set of candidate coding modes from the M angular coding modes according to the confidence level of the dominant gradient direction of the coding unit includes: determining the confidence level of the dominant gradient direction of the coding unit according to a magnitude ratio of the gradient histogram of the dominant gradient direction of the coding unit to the gradient histogram of a secondary gradient direction of the coding unit; in response to the confidence level being greater than a first threshold, determining the set of candidate coding modes from the M angular coding modes according to the angular interval corresponding to the dominant gradient direction of the coding unit; and in response to the confidence level being less than or equal to the first threshold, determining the set of candidate coding modes from the M angular coding modes according to the angular interval corresponding to the dominant gradient direction of the coding unit and the angular interval corresponding to the secondary gradient direction of the coding unit.

According to embodiments of the present disclosure, the dominant gradient direction refers to the angular interval having the maximum total gradient magnitude, and the secondary gradient direction refers to the angular interval having the second maximum total gradient magnitude. The magnitude ratio may refer to a ratio of the total gradient magnitude of the dominant gradient direction to the total gradient magnitude of the secondary gradient direction. The confidence level may represent the reliability of the dominant gradient direction being a dominant texture direction of the coding unit.

In an example, if the confidence level is greater than the first threshold, it indicates a high reliability of the dominant gradient direction of the coding unit being the dominant texture direction of the coding unit. In this case, the angular coding modes corresponding to the dominant gradient direction of the coding unit may be selected as the set of candidate coding modes.

In another example, if the confidence level is less than or equal to the first threshold, it indicates a low reliability of the dominant gradient direction of the coding unit being the dominant texture direction of the coding unit. In this case, the set of candidate coding modes may not be determined solely based on the dominant gradient direction of the coding unit, the angular interval corresponding to the secondary gradient direction may be considered, and the set of candidate coding modes may be determined according to the angular coding modes corresponding to the dominant gradient direction and the angular coding modes corresponding to the secondary gradient direction.

In embodiments of the present disclosure, determining the set of candidate coding modes from the M angular coding modes according to the angular interval corresponding to the dominant gradient direction of the coding unit and the angular interval corresponding to the secondary gradient direction of the coding unit in response to the confidence level being less than or equal to the first threshold includes: in response to the confidence level being less than or equal to the first threshold and greater than a second threshold, determining a set of initial coding modes from the M angular coding modes according to the angular interval corresponding to the dominant gradient direction and the angular interval corresponding to the secondary gradient direction; and in response to the confidence level being less than or equal to the second threshold, determining the M angular coding modes as the set of initial coding modes.

According to embodiments of the present disclosure, when the confidence level is less than or equal to the first threshold, it indicates that the texture of the coding unit is complex and that the dominant texture direction cannot be identified. Therefore, the set of candidate coding modes may not be determined solely based on the dominant gradient direction of the coding unit.

The present disclosure divides the case where the confidence level is less than or equal to the first threshold into two situations. In one situation, the confidence level is less than or equal to the first threshold and greater than the second threshold. This situation indicates that a similarity between the dominant gradient direction of the coding unit and the image texture direction of the coding unit is not high, while the image texture direction is mainly distributed across the dominant gradient direction and the secondary gradient direction. Accordingly, the angular coding modes in the angular interval corresponding to the dominant gradient direction of the coding unit and the angular coding modes in the angular interval corresponding to the secondary gradient direction of the coding unit may be determined as the set of candidate coding modes.

According to embodiments of the present disclosure, the angular coding modes are determined based on the confidence level of the dominant gradient direction of the coding unit, and the set of candidate coding modes may be determined according to the angular coding modes corresponding to the dominant gradient direction and the angular coding modes corresponding to the secondary gradient direction, and then the target coding mode is determined, thereby reducing the computational complexity of intra prediction and improving coding efficiency.

In the other situation, the confidence level is less than or equal to the second threshold. This situation indicates that the texture features of the coding unit are complex, and it is difficult to determine the dominant texture direction of the image according to the dominant gradient direction and the secondary gradient direction. Therefore, the angular interval corresponding to the dominant gradient direction and the angular interval corresponding to the secondary gradient direction may both fail to provide an optimal coding mode. In this case, in order to maintain the accuracy of intra prediction, all angular coding modes need to be included in the set of initial coding modes. The set of initial coding modes may be preliminary screened according to the residual costs of the angular coding modes in the set of initial coding modes. By comparing the residual costs of the angular coding modes, the angular coding modes having lower residual costs may be determined as the set of candidate coding modes.

According to embodiments of the present disclosure, after the set of initial coding modes is determined based on the confidence level, the set of initial coding modes may be screened using the residual costs which have lower computational complexity, thereby obtaining the set of candidate coding modes. The rate-distortion cost may then be calculated for the set of candidate coding modes to obtain the target angular coding mode. Compared with calculating the rate-distortion costs for all angular coding modes, the computational complexity of the present disclosure is reduced, thereby improving the coding efficiency of the encoder.

In embodiments of the present disclosure, the values of the first threshold and the second threshold are related to the size of the coding unit and the QP. For example, the threshold that provides the best trade-off between coding quality and speed may be determined by testing the impact of different thresholds on coding quality and speed for each coding unit at various QPs.

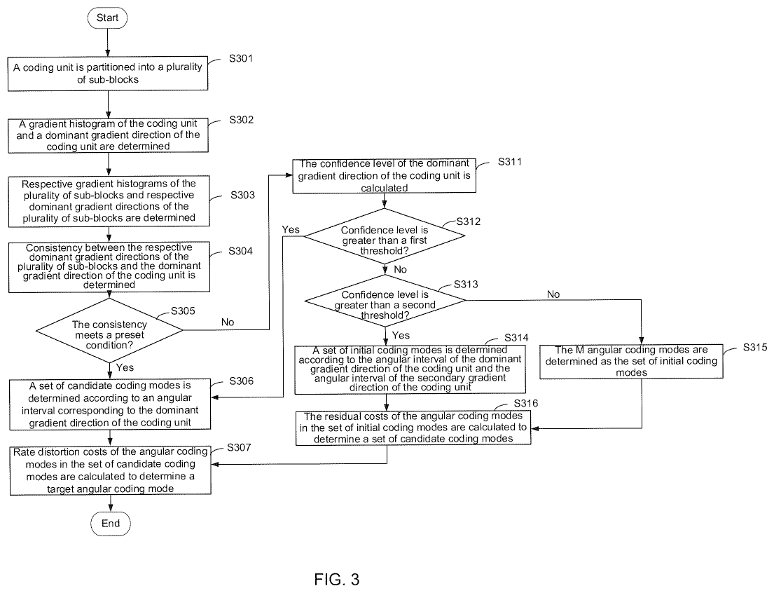

FIG. 3 shows a flowchart of an image coding method according to another embodiment of the present disclosure.

As shown in FIG. 3, the image coding method of this embodiment includes operation S301 to operation S307 and operation S311 to operation S316.

In operation S301, a coding unit is partitioned into a plurality of sub-blocks.

In operation S302, a gradient histogram of the coding unit and a dominant gradient direction of the coding unit are determined.

In operation S303, respective gradient histograms of the plurality of sub-blocks and respective dominant gradient directions of the plurality of sub-blocks are determined.

In operation S304, consistency between the respective dominant gradient directions of the plurality of sub-blocks and the dominant gradient direction of the coding unit is determined.

In operation S305, it is determined whether the consistency meets a preset condition or not. If the consistency between the respective dominant gradient directions of the plurality of sub-blocks and the dominant gradient direction of the coding unit meets the preset condition, operation S306 is performed; if the consistency between the respective dominant gradient directions of the plurality of sub-blocks and the dominant gradient direction of the coding unit does not meet the preset condition, operation S311 is performed.

The preset condition may refer to that the number of sub-blocks whose dominant gradient directions are consistent with the dominant gradient direction of the coding unit is greater than or equal to a quantity threshold, or refer to that a proportion of sub-blocks whose dominant gradient directions are consistent with the dominant gradient direction of the coding unit is greater than or equal to a proportion threshold.

In operation S306, a set of candidate coding modes is determined according to an angular interval corresponding to the dominant gradient direction of the coding unit.

In operation S307, rate distortion costs of the angular coding modes in the set of candidate coding modes are calculated to determine a target angular coding mode.

In embodiments of the present disclosure, if the consistency does not meet the preset condition, it is further needed to calculate a confidence level of the dominant gradient direction. Through operation S311 to operation S316, the confidence level is compared with different thresholds to determine the set of candidate coding modes.

In operation S311, the confidence level of the dominant gradient direction of the coding unit is calculated.

In operation S312, it is determined whether the confidence level is greater than a first threshold. If the confidence level of the dominant gradient direction is greater than the first threshold, the process returns to operation S306; if the confidence level of the dominant gradient direction is less than the first threshold, operation S313 is performed.

In operation S313, it is determined whether the confidence level is greater than a second threshold. If the confidence level of the dominant gradient direction is less than the first threshold and greater than the second threshold, operation S314 is performed; if the confidence level of the dominant gradient direction is less than the second threshold, operation S315 is performed.

In operation S314, a set of initial coding modes is determined according to the angular interval of the dominant gradient direction of the coding unit and the angular interval of the secondary gradient direction of the coding unit.

In operation S315, the M angular coding modes are determined as the set of initial coding modes.

In operation S316, the residual costs of the angular coding modes in the set of initial coding modes are calculated to determine a set of candidate coding modes.

After determining the set of candidate coding modes in operation S316, the process returns to operation S307.

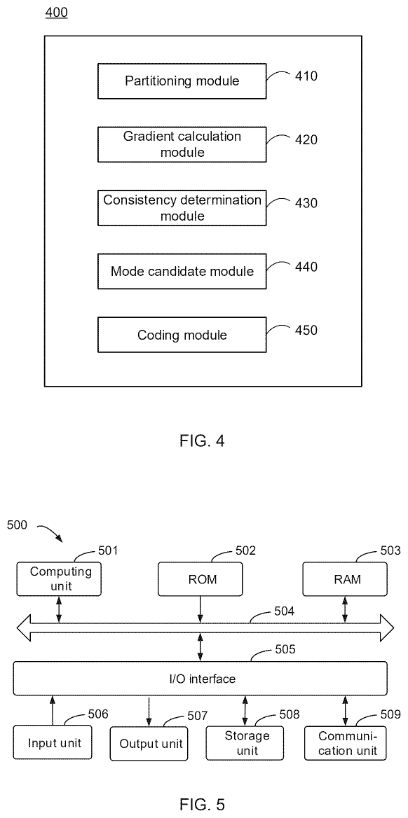

FIG. 4 shows a block diagram of an image coding apparatus according to an embodiment of the present disclosure.

As shown in FIG. 4, an image coding apparatus 400 includes a partitioning module 410, a gradient calculation module 420, a consistency determination module 430, a mode candidate module 440, and a coding module 450.

The partitioning module 410 is used to partition an image to be processed into a plurality of coding units.

The gradient calculation module 420 is used to determine, for any coding unit, a gradient histogram of the coding unit and respective gradient histograms of a plurality of sub-blocks in the coding unit, according to gradients of pixels in the coding unit.

The consistency determination module 430 is used to determine consistency between respective dominant gradient directions of the plurality of sub-blocks and a dominant gradient direction of the coding unit according to the gradient histograms.

The mode candidate module 440 is used to determine a set of candidate coding modes from a plurality of angular coding modes according to the consistency.

The coding module 450 is used to determine a target angular coding mode to encode the coding unit, according to the rate distortion costs of the angular coding modes in the set of candidate coding modes.

In embodiments of the present disclosure, the plurality of angular coding modes include M angular coding modes; the gradient calculation module 420 includes a first determination sub-module and a second determination sub-module.

The first determination sub-module is used to determine N gradient histograms of the coding unit respectively corresponding to N angular intervals according to a distribution of the gradient directions of pixels in the coding unit across the N angular intervals, where the N angular intervals are obtained by dividing M angular directions respectively corresponding to the M angular coding modes, and N is an integer less than M. The second determination sub-module is used to determine, for each sub-block, N gradient histograms of the sub-block respectively corresponding to the N angular intervals according to a distribution of the gradient directions of pixels in the sub-block across the N angular intervals.

In embodiments of the present disclosure, the image coding apparatus 400 further includes a first direction determination module and a second direction determination module.

The first direction determination module is used to determine an angular interval corresponding to a gradient histogram having a maximum magnitude among the N gradient histograms of the coding unit as the dominant gradient direction of the coding unit. The second direction determination module is used to determine, for each sub-block, an angular interval corresponding to a gradient histogram having a maximum magnitude among the N gradient histograms of the sub-block as the dominant gradient direction of the sub-block.

In embodiments of the present disclosure, the mode candidate module 440 includes a first mode candidate sub-module and a second mode candidate sub-module.

The first mode candidate sub-module is used to, in response to the consistency meeting the preset condition, determine a set of candidate coding modes from the M angular coding modes according to the angular interval of the dominant gradient direction of the coding unit. The second mode candidate sub-module is used to, in response to the consistency not meeting the preset condition, determine a set of candidate coding modes from the M angular coding modes according to a confidence level of the dominant gradient direction of the coding unit.

According to embodiments of the present disclosure, the present disclosure further provides an electronic device, a readable storage medium, and a computer program product.

FIG. 5 shows a schematic block diagram of an example electronic device 500 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 501 which may perform various appropriate actions and processes according to a computer program stored in a read only memory (ROM) 502 or a computer program loaded from a storage unit 508 into a random access memory (RAM) 503. In the RAM 503, various programs and data necessary for an operation of the electronic device 500 may also be stored. The computing unit 501, the ROM 502 and the RAM 503 are connected to each other through a bus 504. An input/output (I/O) interface 505 is also connected to the bus 504.

A plurality of components in the electronic device 500 are connected to the input/output (I/O) interface 505, including: an input unit 506, such as a keyboard, or a mouse; an output unit 507, such as displays or speakers of various types; a storage unit 508, such as a disk, or an optical disc; and a communication unit 509, such as a network card, a modem, or a wireless communication transceiver. The communication unit 509 allows the electronic device 500 to exchange information/data with other devices through a computer network such as Internet and/or various telecommunication networks.

The computing unit 501 may be various general-purpose and/or dedicated processing assemblies having processing and computing capabilities. Some examples of the computing units 501 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 501 executes various methods and processes described above, such as the image coding method. For example, in some embodiments, the image coding method may be implemented as a computer software program which is tangibly embodied in a machine-readable medium, such as the storage unit 508. In some embodiments, the computer program may be partially or entirely loaded and/or installed in the electronic device 500 via the ROM 502 and/or the communication unit 509. The computer program, when loaded in the RAM 503 and executed by the computing unit 501, may execute one or more steps in the image coding method described above. Alternatively, in other embodiments, the computing unit 501 may be used to perform the image coding method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An image coding method, the method comprising:
partitioning an image to be processed into a plurality of coding units;
determining, for any one of the plurality of coding units, a gradient histogram of the coding unit and respective gradient histograms of a plurality of sub-blocks of the coding unit, according to gradients of pixels in the coding unit;
determining consistency between respective dominant gradient directions of the plurality of sub-blocks and a dominant gradient direction of the coding unit according to the gradient histograms;
determining a set of candidate coding modes from a plurality of angular coding modes according to the consistency; and
determining a target angular coding mode to encode the coding unit, according to rate-distortion costs of the angular coding modes in the set of candidate coding modes.

2. The method of claim 1, wherein the plurality of angular coding modes comprise M angular coding modes; and
the determining the gradient histogram of the coding unit and the respective gradient histograms of the plurality of sub-blocks of the coding unit according to the gradients of the pixels in the coding unit comprises:
determining N gradient histograms of the coding unit respectively corresponding to N angular intervals, according to a distribution of gradient directions of pixels in the coding unit across the N angular intervals, wherein the N angular intervals are obtained by dividing M angular directions respectively corresponding to the M angular coding modes, and N is an integer less than M; and
determining, for each of the plurality of sub-blocks, N gradient histograms of the sub-block respectively corresponding to the N angular intervals, according to a distribution of gradient directions of pixels in the sub-block across the N angular intervals.

3. The method of claim 2, further comprising:
determining an angular interval corresponding to a gradient histogram having a maximum magnitude among the N gradient histograms of the coding unit as the dominant gradient direction of the coding unit; and
determining, for each sub-block, an angular interval corresponding to a gradient histogram having a maximum magnitude among the N gradient histograms of the sub-block as the dominant gradient direction of the sub-block.

4. The method of claim 2, wherein the determining the set of candidate coding modes from M angular coding modes according to the consistency comprises:
determining the set of candidate coding modes from the M angular coding modes according to the angular interval corresponding to the dominant gradient direction of the coding unit, in response to the consistency meeting a preset condition; and
determining the set of candidate coding modes from the M angular coding modes according to a confidence level of the dominant gradient direction of the coding unit, in response to the consistency not meeting the preset condition.

5. The method of claim 4, wherein the determining the set of candidate coding modes from the M angular coding modes according to the confidence level of the dominant gradient direction of the coding unit comprises:
determining the confidence level of the dominant gradient direction of the coding unit according to a magnitude ratio of a gradient histogram of the dominant gradient direction of the coding unit to a gradient histogram of a secondary gradient direction of the coding unit;
determining the set of candidate coding modes from the M angular coding modes according to the angular interval corresponding to the dominant gradient direction of the coding unit, in response to the confidence level being greater than a first threshold; and
determining the set of candidate coding modes from the M angular coding modes according to the angular interval corresponding to the dominant gradient direction of the coding unit and an angular interval corresponding to the secondary gradient direction of the coding unit, in response to the confidence level being less than or equal to the first threshold.

6. The method of claim 5, wherein the determining the set of candidate coding modes from the M angular coding modes according to the angular interval corresponding to the dominant gradient direction of the coding unit and the angular interval corresponding to the secondary gradient direction of the coding unit in response to the confidence level being less than or equal to the first threshold comprises:
determining a set of initial coding modes from the M angular coding modes according to the angular interval corresponding to the dominant gradient direction and the angular interval corresponding to the secondary gradient direction, in response to the confidence level being less than or equal to the first threshold and greater than a second threshold;
determining the M angular coding modes as the set of initial coding modes, in response to the confidence level being less than or equal to the second threshold; and
determining the set of candidate coding modes from the set of initial coding modes according to residual costs of the angular coding modes in the set of initial coding modes.

7. The method of claim 2, wherein the determining N gradient histograms of the coding unit respectively corresponding to N angular intervals according to the distribution of the gradient directions of the pixels in the coding unit across the N angular intervals comprises:
determining, for each of the N angular intervals, a gradient histogram corresponding to the angular interval according to gradient magnitudes of pixels whose gradient directions are distributed in the angular interval; and
determining N gradient histograms respectively corresponding to the N angular intervals as the N gradient histograms of the coding unit respectively corresponding to the N angular intervals.

8. The method of claim 1, wherein the determining the target angular coding mode to encode the coding unit according to the rate-distortion costs of the angular coding modes in the set of candidate coding modes comprises:
determining, from the set of candidate coding modes, an angular coding mode having a minimum rate-distortion cost as the target angular coding mode to encode the coding unit.

9. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
partition an image to be processed into a plurality of coding units;
determine, for any one of the plurality of coding units, a gradient histogram of the coding unit and respective gradient histograms of a plurality of sub-blocks of the coding unit, according to gradients of pixels in the coding unit;
determine consistency between respective dominant gradient directions of the plurality of sub-blocks and a dominant gradient direction of the coding unit according to the gradient histograms;
determine a set of candidate coding modes from a plurality of angular coding modes according to the consistency; and
determine a target angular coding mode to encode the coding unit, according to rate-distortion costs of the angular coding modes in the set of candidate coding modes.

10. The electronic device of claim 9, wherein the plurality of angular coding modes comprise M angular coding modes; and
the instructions are further configured to cause the at least one processor to at least:
determine N gradient histograms of the coding unit respectively corresponding to N angular intervals, according to a distribution of gradient directions of pixels in the coding unit across the N angular intervals, wherein the N angular intervals are obtained by dividing M angular directions respectively corresponding to the M angular coding modes, and N is an integer less than M; and
determine, for each of the plurality of sub-blocks, N gradient histograms of the sub-block respectively corresponding to the N angular intervals, according to a distribution of gradient directions of pixels in the sub-block across the N angular intervals.

11. The electronic device of claim 10, wherein the instructions are further configured to cause the at least one processor to at least:
determine an angular interval corresponding to a gradient histogram having a maximum magnitude among the N gradient histograms of the coding unit as the dominant gradient direction of the coding unit; and
determine, for each sub-block, an angular interval corresponding to a gradient histogram having a maximum magnitude among the N gradient histograms of the sub-block as the dominant gradient direction of the sub-block.

12. The electronic device of claim 10, wherein the instructions are further configured to cause the at least one processor to at least:
determine the set of candidate coding modes from the M angular coding modes according to the angular interval corresponding to the dominant gradient direction of the coding unit, in response to the consistency meeting a preset condition; and
determine the set of candidate coding modes from the M angular coding modes according to a confidence level of the dominant gradient direction of the coding unit, in response to the consistency not meeting the preset condition.

13. The electronic device of claim 12, wherein the instructions are further configured to cause the at least one processor to at least:
determine the confidence level of the dominant gradient direction of the coding unit according to a magnitude ratio of a gradient histogram of the dominant gradient direction of the coding unit to a gradient histogram of a secondary gradient direction of the coding unit;
determine the set of candidate coding modes from the M angular coding modes according to the angular interval corresponding to the dominant gradient direction of the coding unit, in response to the confidence level being greater than a first threshold; and
determine the set of candidate coding modes from the M angular coding modes according to the angular interval corresponding to the dominant gradient direction of the coding unit and an angular interval corresponding to the secondary gradient direction of the coding unit, in response to the confidence level being less than or equal to the first threshold.

14. The electronic device of claim 13, wherein the instructions are further configured to cause the at least one processor to at least:
determine a set of initial coding modes from the M angular coding modes according to the angular interval corresponding to the dominant gradient direction and the angular interval corresponding to the secondary gradient direction, in response to the confidence level being less than or equal to the first threshold and greater than a second threshold;
determine the M angular coding modes as the set of initial coding modes, in response to the confidence level being less than or equal to the second threshold; and
determine the set of candidate coding modes from the set of initial coding modes according to residual costs of the angular coding modes in the set of initial coding modes.

15. The electronic device of claim 10, wherein the instructions are further configured to cause the at least one processor to at least:
determine, for each of the N angular intervals, a gradient histogram corresponding to the angular interval according to gradient magnitudes of pixels whose gradient directions are distributed in the angular interval; and
determine N gradient histograms respectively corresponding to the N angular intervals as the N gradient histograms of the coding unit respectively corresponding to the N angular intervals.

16. The electronic device of claim 9, wherein the instructions are further configured to cause the at least one processor to at least:
determine, from the set of candidate coding modes, an angular coding mode having a minimum rate-distortion cost as the target angular coding mode to encode the coding unit.

17. A non-transitory computer-readable storage medium having computer instructions therein, wherein the computer instructions are configured to cause a computer to at least:
partition an image to be processed into a plurality of coding units;
determine, for any one of the plurality of coding units, a gradient histogram of the coding unit and respective gradient histograms of a plurality of sub-blocks of the coding unit, according to gradients of pixels in the coding unit;
determine consistency between respective dominant gradient directions of the plurality of sub-blocks and a dominant gradient direction of the coding unit according to the gradient histograms;
determine a set of candidate coding modes from a plurality of angular coding modes according to the consistency; and
determine a target angular coding mode to encode the coding unit, according to rate-distortion costs of the angular coding modes in the set of candidate coding modes.

18. The non-transitory computer-readable storage medium of claim 17, wherein the plurality of angular coding modes comprise M angular coding modes; and
the computer instructions are further configured to cause the computer to at least:
determine N gradient histograms of the coding unit respectively corresponding to N angular intervals, according to a distribution of gradient directions of pixels in the coding unit across the N angular intervals, wherein the N angular intervals are obtained by dividing M angular directions respectively corresponding to the M angular coding modes, and N is an integer less than M; and
determine, for each of the plurality of sub-blocks, N gradient histograms of the sub-block respectively corresponding to the N angular intervals, according to a distribution of gradient directions of pixels in the sub-block across the N angular intervals.

19. The non-transitory computer-readable storage medium of claim 18,
wherein the computer instructions are further configured to cause the computer to at least:
determine an angular interval corresponding to a gradient histogram having a maximum magnitude among the N gradient histograms of the coding unit as the dominant gradient direction of the coding unit; and
determine, for each sub-block, an angular interval corresponding to a gradient histogram having a maximum magnitude among the N gradient histograms of the sub-block as the dominant gradient direction of the sub-block.

20. The non-transitory computer-readable storage medium of claim 18, wherein the computer instructions are further configured to cause the computer to at least:
determine the set of candidate coding modes from the M angular coding modes according to the angular interval corresponding to the dominant gradient direction of the coding unit, in response to the consistency meeting a preset condition; and
determine the set of candidate coding modes from the M angular coding modes according to a confidence level of the dominant gradient direction of the coding unit, in response to the consistency not meeting the preset condition.
